(19) United States
(12) Patent Application Publication
(10) Pub. No.: US 2009/0278958 A1
(43) Pub. Date: Nov. 12, 2009

(54) Method and an apparatus for detecting a composition adjusted

(75) Inventors: Orna Bregman-Amitai, Tel-Aviv (IL); Noam Sorek, Zikhron-Yaakov (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 12/149,824

(22) Filed: May 8, 2008

(51) Int. Cl. H04N 5/76; H04N 5/228

(52) U.S. Cl. 348/231.99; 348/222.1; 348/E05.031

(57) ABSTRACT

A method for capturing a composition adjusted image. The method comprises receiving a base image, processing the base image to derive coordinates of a composition adjusted image having a composition matching with at least one predefined composition rule, and capturing the composition adjusted image according to the coordinates.

### FIELD OF THE INVENTION

This invention, in some embodiments thereof, relates to composing a digital image. Some embodiments relate to a composition according to composition guidelines.

### BACKGROUND OF THE INVENTION

In some cases persons use digital image capturing units without the skill or knowledge of image composition. Some work was done to improve composition or the visual effect or quality of digital images. For example, Serene Banerjee, Composition-Guided Image Acquisition, Ph.D. Defense, Apr. 28, 2004 (http://www.ece.utexas.edu/˜serene).

In many cases, famous or popular or otherwise appreciated works of visual art exhibit patterns and relationships in the organization of features such as objects, lines, shapes, forms and colors that have been recognized to contribute to visual qualities of the art such as a pleasant or expressive or attractive or impressive effect. Some of the patterns have been recognized to follow certain guidelines that became to be known as ‘composition rules’.

Composition rules may be expressed mathematically, though in some cases a graphical or diagrammatic presentation may be more expressive or handy.

Some rules are discussed, for example, in http://photoinf.com, http://www.powerretouche.com/Divine_roportion_tutorial.htm or http://www.colorpilot.com/comp_rules.html, or in citations therein, the disclosures of which are incorporated herein by reference.

### SUMMARY OF THE INVENTION

A broad aspect of some exemplary embodiments of the invention relates to finding a match between visual features in the image effective in a composition and a composition rule.

Typically, without limiting, visual features effective in a composition comprise visually prominent or interesting or attractive features in an image. For example, faces or objects, or a point or an area or a region or a curve, or a combination thereof, which is pronounced such as relative to the surrounding thereof, such as reflection of a setting sun water. Or, for example, a point or an area or a region or a curve which is distinct and/or noticeable and/or attracts, or is capable or expected to attract, the attention of a typical and/or ordinary viewer. For example, a horizon line, or a mountain ridge which not necessarily continuous or straight. In some cases a feature is not present in the image but is perceived to be, for example, a railroad in perspective converging into a perceived distant point.

In the specification, unless otherwise specified, a composition having, or perceived to have, visual qualities such as a pleasant or expressive or attractive or impressive effect will be denoted ‘expressive’.

An aspect of some exemplary embodiments of the invention relates to determining the boundaries of an image based on composition rules, subsequently providing an image in a format according to the determined boundaries, i.e., providing an image in a composition according to the determined boundaries.

An aspect of some exemplary embodiments of the invention relates to determining the boundaries of an image based on composition rules, subsequently providing an image in a format according to the determined boundaries in a digital apparatus capable of acquiring an image (‘a image capturing unit’), such as by taking a snapshot or recording a video. In some embodiments of the invention, the apparatus comprises devices, optionally portable, such as cellular phones, digital image capturing units, video image capturing units or handsets.

According to some embodiments of the present invention there is provided a method for capturing a composition adjusted image. The method comprises a) receiving a base image, b) processing the base image to derive coordinates of a composition adjusted image having a composition matching with at least one predefined composition rule, and c) capturing the composition adjusted image according to the coordinates.

Optionally, the base image depicts at least one composition indicative feature, the processing comprises matching between the at least one composition indicative feature and a predefined template.

More optionally, the predefined template is selected from a group consisting of a face, a person, a posture, a section of a person body, a scenery contour and an animal.

More optionally, the processing comprises evaluating a member selected from a group consisting of: the area of the at least one composition indicative feature, the shape of the at least one composition indicative feature and the contour of the at least one composition indicative feature, the matching being performed according to the evaluation.

Optionally, the base image depicts at least one element, the matching comprises matching between an arrangement of the at least one element in the base image and the at least one predefined composition rule.

Optionally, the processing comprises scoring a plurality of composition indicative features in the base image, the matching being performed according to the scoring.

Optionally, each the predefined composition rule is weighted, the matching being performed according to the weighting.

Optionally, the processing is performed automatically in response after the a).

Optionally, the capturing is performed by an image capturing unit; the capturing comprises instructing the image capturing unit to capture the composition adjusted image according to the coordinates.

More optionally, the image capturing unit instructing comprises a member selected from a group consisting of: zooming the image capturing unit, directing the viewpoint of the image capturing unit, and adjusting the exposure time of the image capturing unit.

More optionally, the capturing comprises cropping the base image to form the composition adjusted image according to the coordinates.

Optionally, the resolution of the base image is lower than the resolution of the composition adjusted image.

Optionally, the base image is a frame of a video sequence.

Optionally, the at least one predefined composition rule is selected from a group consisting of: the rule of thirds, the rule of golden diagonals, the rule of harmonious diagonals, and the rule of golden sections, the rule of golden spiral.

Optionally, the, further comprising preprocessing the base image before the b), wherein the preprocessing is selected from a group consisting of: converting the base image to a gray-scale image, binarizing the base image, distinguishing edges in the base image, and segmenting visual elements having an area above a size threshold.

Optionally, capturing comprises combining at least a part of the base image with at least a part of the captured image.

Optionally, the receiving comprises accessing a storage unit hosting the base image.

Optionally, the receiving comprises using an image capturing unit for capturing the base image.

Optionally, the method further comprises creating a downgraded base image before the b), the downgraded base image having lower resolution than the base image, the processing being performed on the downgraded base image.

Optionally, the capturing comprises capturing a new image and combining at least one region of the base image with the at least one region of the new image, thereby creating the composition adjusted image.

Optionally, the base image is captured by an image capturing device, further comprising indicating a user to maneuver the image capturing device according to the composition adjusted image before the c).

Optionally, the processing comprises scoring a plurality of composition indicative features in the base image, the indicating being performed according to the scoring.

According to some embodiments of the present invention there is provided an apparatus for capturing a composition adjusted image. The apparatus comprises an image capturing unit configured for capturing a base image, a memory configured for storing a plurality of predefined composition rules, a composition analysis module configured for analyzing the base image and deriving coordinates of a composition adjusted image therefrom, the composition adjusted image having a composition matching with at least one of the plurality of predefined composition rules, and a capturing module configured for capturing the composition adjusted image according to the coordinates.

Optionally the apparatus comprises a user interface for displaying an indicator indicative of a recommended maneuver for maneuvering the image capturing unit, the recommended maneuver being calculated according to the compliance of the base image with the plurality of predefined composition rules.

Optionally, the capturing module is configured for instructing the image capturing unit to capture the composition adjusted image.

Optionally, the image capturing unit is configured for capturing the base image in a first resolution and the composition adjusted image in a second resolution, wherein the first and second resolutions are different.

More optionally, the capturing module is configured for instructing the image capturing unit by a member selected from a group consisting of: zooming the image capturing unit, directing the viewpoint of the image capturing unit, and adjusting the exposure time of the image capturing unit.

Optionally, the capturing module is configured for capturing a new image and combining at least one region \of the base image with at least one region of the new image.

Optionally, the apparatus is selected from a group consisting of: a mobile phone, a personal digital assistant (PDA), and a handheld computing unit.

According to some embodiment of the present invention there is provided a method for capturing a composition adjusted image. The method comprises a) receiving a base image from an image capturing device, b) processing the base image to derive a plurality of coordinates each of a composition adjusted image having a composition matching with at least one predefined composition rule, c) scoring each coordinate according to a compliance of the composition adjusted image with a respective the at least one predefined composition rule, and d) using the scoring for indicating a recommended maneuver for the image capturing device.

Optionally, the method further comprises allowing a user to capture a final image after maneuvering the capturing device according to the recommended maneuver.

In the specifications, unless otherwise specified, the image used to determine a composition is referred to as a ‘base image’, and the image provided according to a determined composition is denoted as ‘composition adjusted image’.

In the specifications and claims, unless otherwise specified, the term image ‘acquisition’ and image ‘capture’, and inflections thereof, may be used interchangeably denoting digitally recording a visual scene, where ‘image providing’ and inflections thereof denote obtaining an image in any method, comprising, inter alia, acquiring an image, accessing an image in a storage, receiving an image by communications and storing an image.

In the specifications and claims, unless otherwise specified, the term ‘crop’ or inflections thereof denote modifying the boundaries of an image, discarding regions that lie outside the modified boundaries.

In the specifications and claims, unless otherwise specified, the term ‘rule’ denotes a composition guideline, or composition rule, as known in the art.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the accompanying drawings, identical and/or equivalent and/or similar structures, elements, or parts that appear in more than one drawing are generally labeled with the same numeral in the drawings in which they appear. Dimensions of components and features shown in the figures are chosen for convenience or clarity of presentation and are not necessarily shown to scale.

FIG. 1 is a flowchart schematically illustrating operations in formatting an image based on composition rules, in accordance with exemplary embodiments of the invention;

FIG. 2 schematically illustrates an image capturing unit, in accordance with exemplary embodiments of the invention;

FIG. 3A schematically and graphically illustrates a ‘rule of thirds’, in accordance with exemplary embodiments of the invention;

FIG. 3B schematically and graphically illustrates a ‘rule of golden diagonals’, in accordance with exemplary embodiments of the invention;

FIG. 3C schematically and graphically illustrates a ‘rule of harmonious diagonals’, in accordance with exemplary embodiments of the invention;

FIG. 3D schematically and graphically illustrates a ‘rule of golden sections’, in accordance with exemplary embodiments of the invention;

FIG. 3E schematically and graphically illustrates a ‘rule of golden spiral’, in accordance with exemplary embodiments of the invention;

FIG. 3F schematically and graphically illustrates a guideline template for a portrait, in accordance with exemplary embodiments of the invention;

FIGS. 3G-3I are schematic illustrations of exemplary layouts, according to some embodiments of the present invention;

FIG. 3J is a flowchart of a method for capturing an image having a preferred composition using inputs which are received from a user, in accordance with some embodiments of the invention;

FIG. 4A illustrates an intersection and conjunctions of lines, as indicated by a white circle, in accordance with exemplary embodiments of the invention;

FIG. 4B illustrates a perceived conjunctions of lines (lines attractor), as indicated by a white circle, in accordance with exemplary embodiments of the invention;

FIG. 4C illustrates a region of distinct contrast to the surrounding, as indicated by a white oval, in accordance with exemplary embodiments of the invention;

FIG. 4D illustrates a region of brightest region, as indicated by a white circle, in accordance with exemplary embodiments of the invention;

FIG. 4E illustrates a child where the face is indicated by a white circle, in accordance with exemplary embodiments of the invention;

FIG. 4F illustrates three distinct objects (cheetahs) where one is indicated by a white oval, in accordance with exemplary embodiments of the invention;

FIG. 5 is a flowchart schematically illustrating operations in formatting an image based on composition rules with some elaborations relative to FIG. 1, in accordance with exemplary embodiments of the invention;

FIG. 6A illustrates a gray-scaled image, in accordance with exemplary embodiments of the invention;

FIG. 6B illustrates gradients of the image of FIG. 6A (with some visibility enhancement), in accordance with exemplary embodiments of the invention;

FIG. 6C illustrates binarized gradients of the image of FIG. 6B (with some visibility enhancement), in accordance with exemplary embodiments of the invention;

FIG. 6D illustrates a gray-scaled image of FIG. 6A overlaid with a rule of thirds, in accordance with exemplary embodiments of the invention;

FIG. 6E illustrates the image of FIG. 4E (with high brightness for clarity) overlaid with a template for face side, in accordance with exemplary embodiments of the invention;

FIG. 7A illustrates the image of FIG. 6E after re-capture (or cropping) according to the rule of thirds, in accordance with exemplary embodiments of the invention;

FIG. 7B illustrates the image of FIG. 4E after re-capture (or cropping) according to the template of a person figure section, in accordance with exemplary embodiments of the invention; and

FIG. 8 schematically illustrates a how an image is appended to a base image in order to provide missing scenery for a composition, in accordance with exemplary embodiments of the invention.

### DESCRIPTION OF EMBODIMENTS OF THE INVENTION

This invention, in some embodiments thereof, relates to capturing digital images. Some embodiments relate to capturing an image according to one or more composition rules.

An aspect of some exemplary embodiments of the invention relates to a method and an apparatus for automatically identifying the coordinates of a composition adjusted image having a preferred composition according to one or more elements which are depicted in the base image and/or the arrangement thereof. The method is based on receiving a base image, processing it to derive the coordinates of a composition adjusted image that have a composition that matches to a predefined composition rule, and capturing the prospective composition adjusted image according to the coordinates. For clarity, the coordinates define or may be used to derive the boundaries of the composition adjusted image and/or a set of instructions that may be used for acquiring the composition adjusted image.

The preferred composition is identified by detecting a combination or an arrangement of elements that matches to one or more predefined composition rules each defines one or more elements, a predefined combination of elements, and/or a predefined arrangement of elements which may be referred to herein as composition indicative features. Optionally, the aforementioned coordinates define the composition adjusted image, which may be referred to herein as a composition adjusted image, and may be used for capturing composition adjusted image and/or for cropping the composition adjusted image from the base image composition adjusted image.

An aspect of some exemplary embodiments of the invention relates to configuring an image capturing unit, such as an image capturing unit of a mobile phone, to automatically determine the coordinates of the composition adjusted image based on a match between composition indicative features and composition rules. As used herein a composition indicative feature means a prominent feature or element, an arrangement of prominent features or elements, and/or a ratio between a prominent feature or element and another prominent feature or element, a background, and/or another element which is depicted in the base image.

In some embodiments of the invention, the device is controlled by software and/or hardware modules to capture an image in a format determined by a previously acquired image. Optionally, the captured image comprises larger extents than shown to the operator of the device (‘user’).

An aspect of some exemplary embodiments of the invention relates to automatically determining a composition based on matching between composition rules composition indicative features according to a relative importance (expressed as ‘weight’) of a composition indicative feature. For example, the more important features are matched with rules matched first, and if no rule is met, less important features are match, in a decreasing order of importance.

The non-limiting section headings used herein are intended for convenience only and are not to be considered as necessarily limiting the scope of the invention.

### Operation Overview

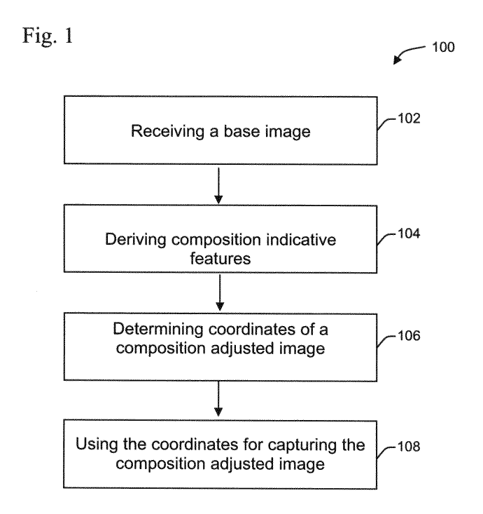

Reference is now made to FIG. 1, which is a flowchart 100 of a method for capturing an image having a preferred composition, in accordance with exemplary embodiments of the invention.

As shown at 102, a base image is received from an image capturing unit and/or from an internal or external source, for example as described below. Then, as shown at 104, the acquired base image is processed and one or more features which are indicative on a certain visual composition are detected. Such features may be referred to herein as composition indicative features. In some embodiments, a composition indicative feature is identified subsequent to a preprocessing of the base image. Such a preprocessing may include an enhancing or, distinguishing element in the base image in relation to other elements in the base image, and/or extracting or obscuring one or more elements in the base image.

In some embodiments, coordinates of a composition adjusted image that depicts one or more of the composition indicative features in a manner that comply with one or more composition rules are automatically identified (106). The coordinates of the composition adjusted image optionally define the boundaries of the composition adjusted image. The composition of the composition adjusted image is determined by matching one or more composition rules with one or more composition indicative features which are detected in the base image. As further described below, the composition indicative features comply with a number of composition rules. Optionally, the compliance of the composition indicative features with a number of composition rules is ranked. The higher is the compliance of the composition indicative features with a certain rule, the higher is the rank. In such an embodiment, the coordinates of the composition adjusted image are determined according to the ranking. Optionally, if the derived composition indicative features do not fit any composition rule, no coordinates are calculated.

After the one or more composition rules are determined, the coordinates of a composition adjusted image are calculated. The coordinates are optionally used for acquiring the composition adjusted image (108).

In some embodiments of the invention, each derived composition indicative feature is assigned with one or more scores reflecting the relative importance thereof, optionally as described below. Optionally, the derived features are matched with one or more rules according to their respective scores, starting with the feature of the highest score.

### Image Capturing Unit and Image Capture

In some embodiments of the invention, an image capturing unit for capturing an image that complies with one or more composition rules is disclosed. The image capturing unit includes an image sensor, such as a charge coupled device (CCD) sensor, a complementary metal oxide semiconductor (CMOS), and the like, for capturing the base image. Optionally, the image capturing is integrated into a mobile phone, a personal digital assistant (PDA), a handheld device, and/or any computing unit with an integrated camera. Optionally the image capturing unit is connected to a screen, such as a viewfinder or the integrated screen of the mobile phone. Optionally, the scene which is currently captured by the image capturing unit is displayed on the screen. Optionally, the base image is the last captured image. Optionally or alternatively, the base image is retrieved from a storage unit which may be an internal storage unit a detachable memory, and/or a remote storage unit which is accessible via network. In some cases or embodiments, the image capturing unit is designed for capturing a video sequence, and an image is a frame of the video sequence.

In some cases or embodiments, the image capturing unit is equipped with a composition analysis module for analyzing the elements which are depicted in the base image and instructing the image sensor to capture the prospective image according to the coordinates which are calculated according to the analysis. Optionally, the image capturing unit is equipped with a control unit that enables the image capturing unit to control parameters, such as zoom, focus, and/or speed of the image sensor. Optionally, the control unit is designed for adjusting the viewing direction of the optical system of the image sensor.

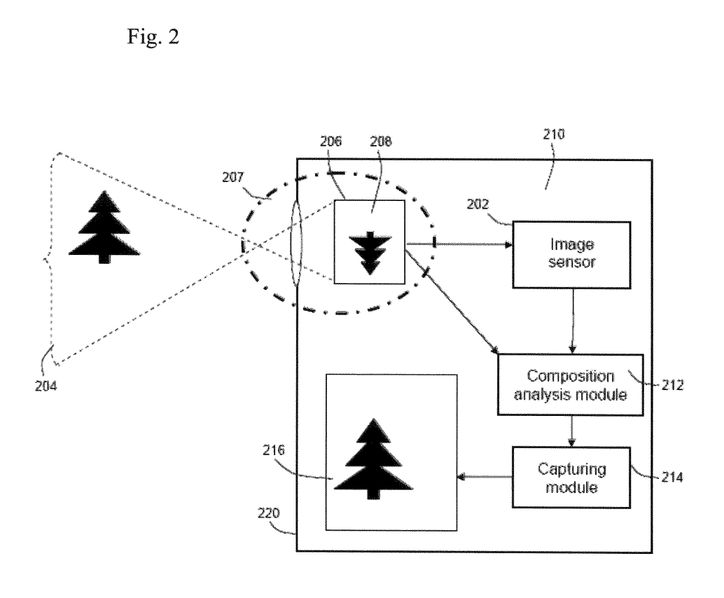

Reference is now made to FIG. 2, which is a schematic illustration of an image capturing unit 220, in accordance with exemplary embodiments of the invention.

In some embodiments of the present invention, the image sensor 202 comprises an optical system 207 with one or more lenses and/or optical elements that projects an image 208 of a scene 204 on the receiving side of the image sensor, for example the imager of a CCD and/or CMOS chip. In some cases or embodiments, an image 208 is stored in a memory of image capturing unit 220 as the base image for detecting the composition indicative features, optionally as outlined above and/or described below.

In some embodiments of the invention, image capturing unit 220 is equipped with a composition analysis module 212 that comprises hardware and/or software, that determines the coordinates for a composition adjusted image on the basis of composition indicative features which are detected in the base image according to composition rules, optionally as overviews above and elaborated below.

In some embodiments of the invention, image capturing unit 220 is also equipped with a capturing module 214 for instructing the image sensor to capture the composition adjusted image 216 and/or to crop composition adjusted image 216 from the base image composition adjusted image according to the coordinates which are calculated by the composition analysis module 212. Optionally, capturing module 214 controls the optical system 207 of the image sensor 202 according to the coordinates which are calculated by the composition analysis module 212. Optionally or alternatively, the capturing module 214 controls the direction of lenses of optical system 207 of the image sensor 202 and/or changes the zooming thereof, thereby captures a larger image that depicts area around the base image or a smaller image that does not depict some areas of the scene 204 which are depicted in the base image. Optionally or alternatively, the capturing module 214 crops the base image or a copy thereof for creating the composition adjusted image.

In some embodiments of the invention, composition analysis module 212 and capturing module 214 are combined. Preferably, without limiting, the operation of composition analysis module 212 and capturing module 214 is automatic comprising no manual intervention. Optionally, the operation of composition analysis module 212 and/or capturing module 214 is invoked by a user.

Rules and their Presentation

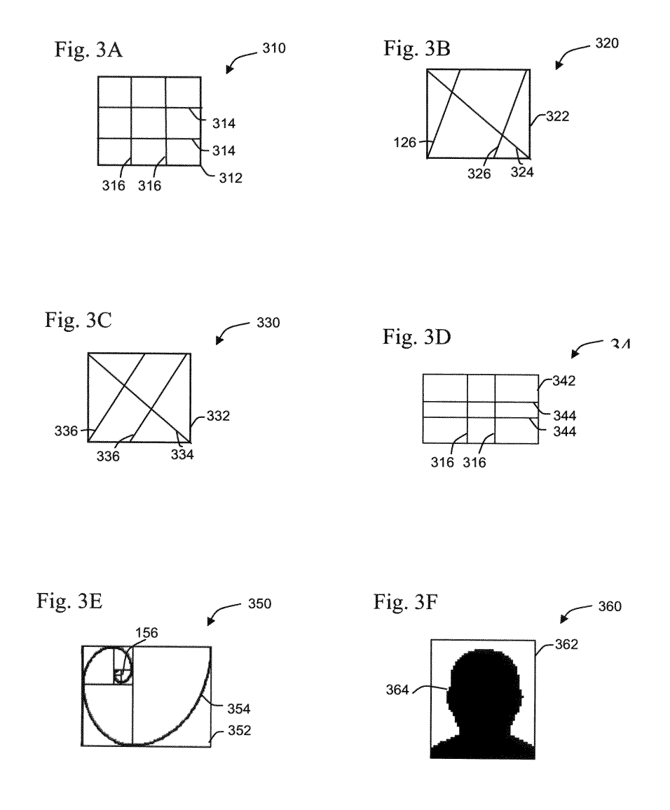

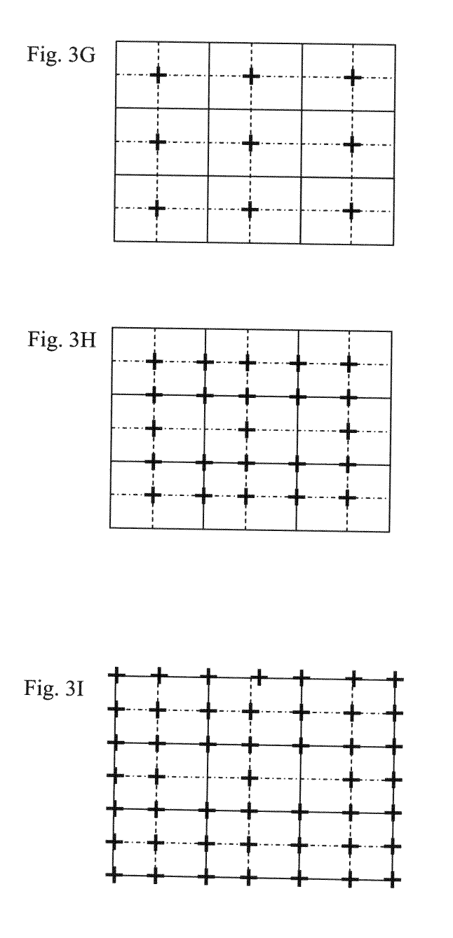

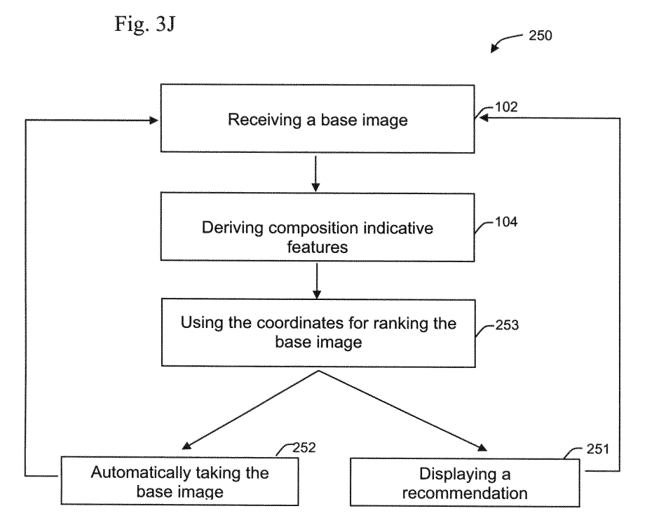

Reference is now made to FIGS. 3A-3F which are schematic illustrations of exemplary patterns; each reflects a different composition rule which may match with the base image in order to identify the coordinates of the composition adjusted image, according to some embodiments of the present invention.

Reference is also made to FIGS. 3G-3I which are schematic illustrations of exemplary layouts, according to some embodiments of the present invention. Optionally, the composition rules are evaluated on the base image in relation to one or more layouts. Optionally, the layout is selected from one or more of the following layouts:

1. A grid of 105% of the base image, 9 options, as shown in FIG. 3G, which apply x-axis shift in steps of 2.5% percent of the width, y-axis shift in steps of 2.5% of the height.

2. A grid of the size of the frame, 25, as shown in FIG. 3H, options that apply x-axis shift in steps of 2.5% percent of the width, y-axis shift in steps of 2.5% of the height.

3. A grid that covers 95% of the frame, 49 options, as shown in FIG. 3I, that apply x-axis shift in steps of 2.5% percent of the width, y-axis shift in steps of 2.5% of the height.

4. Layouts 1-3 using a diminished version of the base image, for example a version that covers only 85% thereof.

It should be noted that as the grid may exceed the frame borders, the calculations are related to the lines and contra-points within the borders of the base image.

FIG. 3A schematically and graphically illustrates a ‘rule of thirds’ 310, in accordance with exemplary embodiments of the invention. In some embodiments of the present invention a frame 312 is defined around two lines 314 that divide it horizontally into 3 equal parts, and two lines 316 that divide it vertically into 3 equal parts. Typically, without limiting, a composition is expressive when a prominent feature is about or centered at an intersection of lines 314 and 316, or if a prominent quasi-linear feature is about or aligned with one of lines 314 or 316. Optionally, a prominent feature and/or a prominent element is defined herein as an element that is depicted in an area having a size above a certain bottom threshold and optionally does not exceed a certain ceiling threshold, for example an element that captures more than an eighth of the size of the base image but no more than a half of the size of the base image.

As described above, the compliance of the base image with composition indicative composition rules is scored. Optionally, the compliance of the base image with the ‘rule of thirds’ (ROT) is scored as follows:
For each dominant gradient line and dominant line in the base image:
Score according to lines which are far from vertical or horizontal by approximately more than a predefined threshold and multiple the score by a negative factor that increases with the length of the line.
Score according to lines close to vertical or horizontal line in used layout, find the closest line between the ROT grid lines and the dashed line; see FIGS. 3G-3I.
Score according to base lines by one or more of the following set of factors:

a factor that increases as line is longer;

one or more factors that increases as the line is closer to vertical or horizontal; and

a factor that relates to the intensity of the line.
If the closest line is a ROT line, multiple the score by a positive factor.
If the closest line is dashed line, as shown in FIGS. 3G-3I multiple the score by a negative factor.
Apply similar method on features relating to ROT points with relatively high positive factor, ROT dash line junctions with relatively low negative factor, and dashed junction with relatively high negative factor.

FIG. 3B schematically and graphically illustrates a ‘rule of golden diagonals’ 400, in accordance with exemplary embodiments of the invention. In some embodiments of the present invention, a frame 322 is defined around two lines 326 that divide it into 2 equal ‘golden’ triangles, and around a diagonal line 324 divides it diagonally to 2 equal parts. Typically, without limiting, a composition is expressive when a prominent feature, optionally as defined above, is depicted about or at the center of an intersection of lines 324 and 326, or if a prominent quasi-linear feature is depicted about or in alignment with one of lines 324 or 326.

FIG. 3C schematically and graphically illustrates a ‘rule of harmonious diagonals’ 600, in accordance with exemplary embodiments of the invention. In some embodiments of the present invention a frame 332 is defined around two lines 336 that divide it into 2 equal harmonious triangles, and around a diagonal line 334 divides it diagonally into 2 equal parts.

Typically, without limiting, a composition is expressive when a prominent feature is depicted about at the center of an intersection of lines 334 and 336, or if a prominent quasi-linear feature is depicted about or in alignment with one of lines 334 or 336.

FIG. 3D schematically and graphically illustrates a ‘rule of golden sections’ 340, in accordance with exemplary embodiments of the invention. In some embodiments of the present invention, a frame 342 is defined around two lines 344 and two lines 346 divide each other in a golden ration relative to the extent thereof. Typically, without limiting, a composition is expressive when a prominent feature, which is optionally as defined above, is depicted about or centered at an intersection of lines 344 and 346, or if a prominent quasi-linear feature is depicted about or in alignment with one of lines 344 or 346.

FIG. 3D schematically and graphically illustrates a ‘rule of golden spiral’ 350, in accordance with exemplary embodiments of the invention. In some embodiments of the present invention, a frame 352 is defined and a golden spiral 354 is curing inward to form an ‘eye’ 356. Typically, without limiting, a composition is expressive when a prominent curve is following about spiral 354, and/or a prominent feature is depicted about or at the center of the eye 356.

FIG. 3F schematically and graphically illustrates a guideline template 360 for a portrait, in accordance with exemplary embodiments of the invention. In some embodiments of the present invention, a frame 362 is defined and a contour or silhouette, which may be referred to herein as a template, 364 defines the section of a person body, for example a face and/or shoulders, for an expressive portrait. Optionally, the frame is ignored, for example, when the person is accompanied by other persons and/or one or more prominent elements. In some embodiments of the invention, other templates may be defined for other postures or body sections of persons or animals, optionally based on age. Optionally, other templates may be defined for other objects such as common buildings, cars, and/or scenery contours. In some embodiments of the invention, templates, such as shown at 360, may be used for detecting and/or identifying objects, such as a natural element or any part thereof, an urban element or any part thereof, a household element of part thereof, a transportation element of part thereof or an animal body or part thereof.

In some embodiments of the invention, the composition rules may be transformed such as by mirroring, rotation or scaling, where scaling may, in some cases, be subject to preserving the rule's elements proportions, e.g., keeping the golden ratio.

In some embodiments of the invention, other composition rules that are not shown and/or discussed may be used in a similar manner according to some embodiments of the invention with respect to the shown and/or discussed composition rules.

In some embodiments of the invention, the composition rules are defined mathematically, optionally as a parameterized formula.

In some embodiments of the invention, the composition rules as a graphical presentation and/or mathematical presentation are provided from a storage, such as firmware, a file or other methods such as hardware.

Some composition rules are described, at least partly, in http://powerretouche.com/Divine_proportion_tutorial.htm, http://www.anandtech.com/digitalcameras/showdoc.aspx?i=2280&p=2, http://www.shotaddict.com/wordpress/2007/01/11/2472.html, http://www.colorpilot.com/comp_rules.html, http://photoinf.com/, or references therein, which are incorporated herein by reference.

Reference is now also made to FIG. 3J, which is a flowchart 150 of a method for capturing an image having a preferred composition using inputs which are received from a user, in accordance with some embodiments of the invention. Blocks 102, 104, and 106 are as depicted in FIG. 1. However, the flowchart further depicts blocks 251-255 that allows the user to determine and/or to influence on a composition that is selected for the captured image. Optionally, the image capturing unit 220 further comprises a user interface for allowing the user to interactively participate in the process of acquiring the captured image. Optionally, the image capturing unit 220 is a cellular phone that comprises a display and a standard twelve key telephone keypad or a touch screen that allows the user to input instructions. The keypad is optionally displayed on a touch screen.

As described above, the image capturing unit 220 is designed to identify composition indicative features, which are indicative on various visual compositions in the acquired base images. As further described above, and shown at 253, each derived composition indicative feature is assigned with one or more scores that reflect the relative importance thereof. Optionally, the user interface is used for displaying a current score of an acquired base image and/or a recommendation to take the image, as shown at 251. Optionally, the image is taken automatically when the score of the acquired base image is above a certain threshold, as shown at 252. As shown at 254 and 255, the processes which are described in FIG. 1B may be repeatedly performed for each acquired base image.

Optionally, the UI may be used for instructing during the image capturing process. In such an embodiment, the aforementioned composition indicative features are used for scoring base images which are captured by the image capturing unit 220 according to their compliance with aforementioned composition rules. Then, the UI instructs the user how to maneuver the image capturing unit 220 it captures a base image with high score. For example, the image capturing unit 220 scores each one of the options of one or more of the layouts which are depicted in FIG. 3G-3H and output a recommendation and/or an indication to maneuver the image capturing unit 220, such as an arrow or a zoom in or out icon, according to the option with the highest score. Optionally, a number of recommendations and/or indications are displayed to the user. In such an embodiment, each recommendation and/or indication is displayed in association with the scoring thereof. In such a manner, the user may select the recommendation and/or indication she rather to follow, inter alia, according to the scoring. In such a manner, the user can capture an image that depicts a selected object even if the composition of the image did not receive the highest score.

For example, if highest grade is for shift left by at least 2.5%, the UI displays an indication, such as an arrow, that advises the user to maneuver his device in a manner that the captured frame is left the current captured frame.

Optionally, if the highest score implies that the image that is captured as an outcome of zooming, a respective indication is displayed. Optionally, after the user maneuvers the image capturing unit 220, all the optional composition options are recalculated. The scoring of a current base image may be based on scores which have been given to previously captured base images. In such a manner, redundant calculation may be avoided.

In some embodiments of the present invention, the user instructs the image capturing unit 220 to start a capturing process in which a base image is captured and a number of possible images with predefined compositions are scored, optionally as described above. Then, the image capturing unit 220 optionally holds until it receive image capturing instructions from a user. Now, the image capturing unit 220 captures the image with the highest score. Optionally, more than one of the scored possible images are captured and displayed to the user. In such an embodiment, the user may select image she likes best. Optionally, as described above, the image capturing unit 220 is a camera and/or a mobile phone. In such an embodiment, the captured image may not be the image that is displayed on the viewfinder and/or screen of the image capturing unit 220.

### Prominent Features (Composition Indicative Features)

In some embodiments of the invention, an expressive composition is achieved by matching composition indicative features in an acquired base image (502) to composition rules.

In some embodiments of the invention, a composition indicative feature comprises at least one of the following:

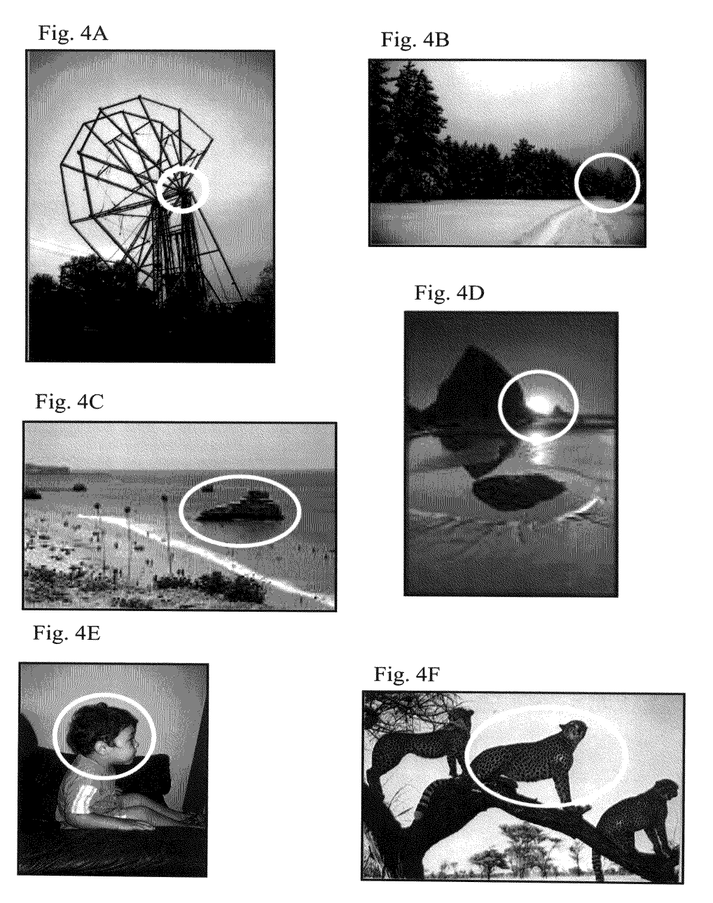

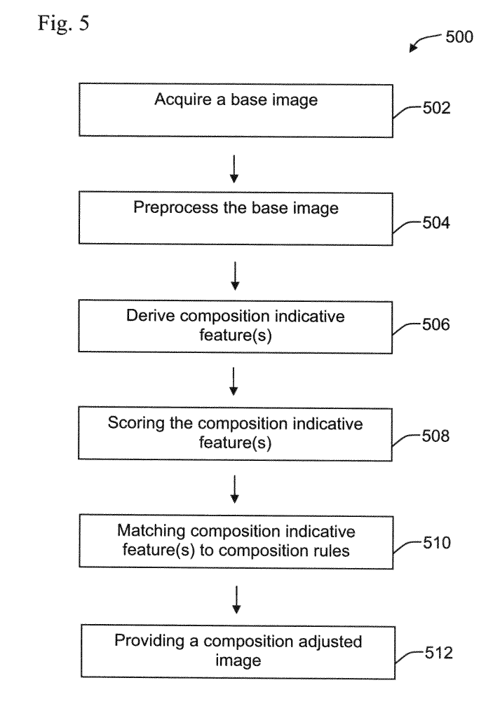

(a) Intersection or conjunctions of lines or curves, for example, FIG. 4A. Such an intersection or conjunctions of lines may be detected using known methods for detecting lines, for example as described in http://homepages.inf.ed.ac.uk/rbf/HIPR2/linedet.htm, which the content thereof is incorporated herein by reference.

(b) Perceived intersections or conjunctions of lines or curves, or of imaginary lines or curves (lines attractors), such a vanishing point of a road or rows of trees, for example as shown at FIG. 4B.

(c) Region of striking contrast to the surrounding, for example as shown at FIG. 4C. Such a region of striking contrast may be detected using a known segmentation algorithm or by applying the following segmentation process that is based on the following steps on a grayscale version of the analyzed image:

smoothing the image by box filter and/or a Gaussian filter;

converting the representation of each pixel, which is optionally a value in a range between 0 and 255, to a value of a smaller scale, such as a value between 1 and 5;

removing objects with a relativity small area, for example using an erosion and/or deletion filters; and

defining areas with a center that includes pixels with high values, such as 5, and edges that includes [symbol] medium values, such as 3 or 4, as striking points.

(d) Brightest or darkest region, for example as shown at FIG. 4D. Such regions may be may be detected using known segmentation algorithms and/or applying the aforementioned segmentation process and defining the center of one or more of the areas which are defined on (d) as the brightest and/or the darkest regions.

(e) Faces, for example as shown at FIG. 4E. Face can be detected using any known method for detecting faces, for example using a Viola-Jones face detecting process, see Paul Viola et al., Robust Real-Time Face Detection, Received Sep. 10, 2001; International Journal of Computer Vision 57(2), 137-154, 2004, which is incorporated herein by reference.

(f) objects, for example, FIG. 4F.

### Outline of Operations

FIG. 5 is a flowchart schematically illustrating operations in formatting an image which is based on composition rules with some elaborations relative to FIG. 1, in accordance with exemplary embodiments of the invention. Operations 502-512 of FIG. 5 will be referenced in the following discussions to provide a frame of reference for the sequence of operations discussed below.

### Composition Indicative Features Derivation

In some embodiments of the invention, the base image is preprocessed (504) before applying procedures for identification of composition indicative features. In some embodiments a color image is converted to a gray-scale image, optionally with a reduction of the gray range, or other windowing operations, comprising a binarization when applicable, for example, when the image has high contrast. In some embodiments of the invention, for example when distinct colored regions appear similar in a gray-scale image, a color separation is performed, for example by hue range or RGB, into a plurality of separated images, and further operations are performed on the separated images.

In some embodiments of the invention, composition indicative features or parts thereof are derived or distinguished (506) by applying edge detection techniques and/or gradient techniques or segmentation techniques. For example, using the Sobel, Roberts, Prewitt, isotropic, and/or Laplace derivation techniques, optionally by using moving kernels. Some of the techniques, are described in John C. Russ, The Image Processing Handbook, 2nd Edition, CRC Press 1995 (ISBN 0-8493-2516-1) and in Anil K Jain, Fundamentals or Digital Image Processing, Prentice-Hall International 1989 (ISBN 0-13-332578-4), which are incorporated herein by reference. It should be noted that these derivation techniques are known to the skilled in the art and therefore not further described herein.

In some embodiments of the invention, the edge detection techniques, color separation image, and/or gradient techniques are applied on a gray-scale image. Optionally, the resultant image is binarized for a convenient isolation and/or identification of the composition indicative features such as lines, curves, closed or semi-closed regions. In some embodiments of the invention, lines or curves or regions are closed, or smoothed, or their boundaries or convex hull are obtained by morphological methods, such as erosion, dilation. combination and/or any variation and/or combination thereof, see John C. Russ, The Image Processing Handbook, 2nd Edition, CRC Press 1995 (ISBN 0-8493-2516-1) and in Anil K Jain, Fundamentals or Digital Image Processing, Prentice-Hall International 1989 (ISBN 0-13-332578-4), which are incorporated herein by reference. Optionally, a curve resembling a closed form but having gaps therein is closed by filling in the gaps by linear or curvilinear segments. In some embodiments of the invention, straight or semi-straight lines, even non continuous ones, may be determined, for example, by a Hough transform, as described in the above cited references. Optionally, the image is segmented to obtain regions or forms of particular objects or parts thereof using, at least partly, methods as described in the cited reference above or other methods of the art.

In some embodiments of the invention, a gradient derived or distinguished on a gray-scale image, which may be understood herein as any color separated image, is binarized according to a gradient value, which may be referred to herein as steepness, such that values below a calculated or set threshold are set to 0 and the rest are set to 1 (or other two distinct values). For example, the mean and standard deviation of the gradients values are obtained, and gradients above the mean +standard deviation are set to 1 and the rest to 0.

Optionally, the base image has a relatively low resolution and the composition adjusted image is captured as an image that has relatively high resolution. As used herein, a low resolution means quarter video graphics array (QVGA) resolution or any resolution which is about the QVGA resolution and a high resolution means a video graphics array (VGA) resolution or higher. Optionally, the base image is sampled down from an original image that is captured and or provided from a storage device, for example as described above. In such an embodiment, the identification of composition indicative features requires less computational power as it is carried out by analyzing an image with relatively low resolution image. It should be noted that as the composition adjusted image is captured as an image with relatively high resolution, the outcome of the process is nor degraded composition adjusted image. For clarity, lower resolution reduces the computation load and enables faster processing as typically the number of computation steps increases with the resolution of the processed image. Optionally, using the low resolution is more robust and/or reliable as small details that may interfere in identifying features are discarded by the down sampling. Optionally or alternatively, the image may be pre-processed to discard small details, for example, by smoothing and subsequent sharpening, or other methods of the art.

### Composition Indicative Features Scoring

In some cases, an image may comprise a plurality of prominent features which are, or at least part of which are, incompatible with a particular composition rule or a particular application of a composition rule, e.g., one feature is suitable for the upper third line and another to the lower left intersection of a ‘rule of thirds’, but not simultaneously. Therefore, in some embodiments of the invention, composition indicative features are scored (508), optionally according to the respective importance, visual effect and/or compositional effectiveness, and the one or more composition indicative features with the highest scores are analyzed for a compliance with the composition rules.

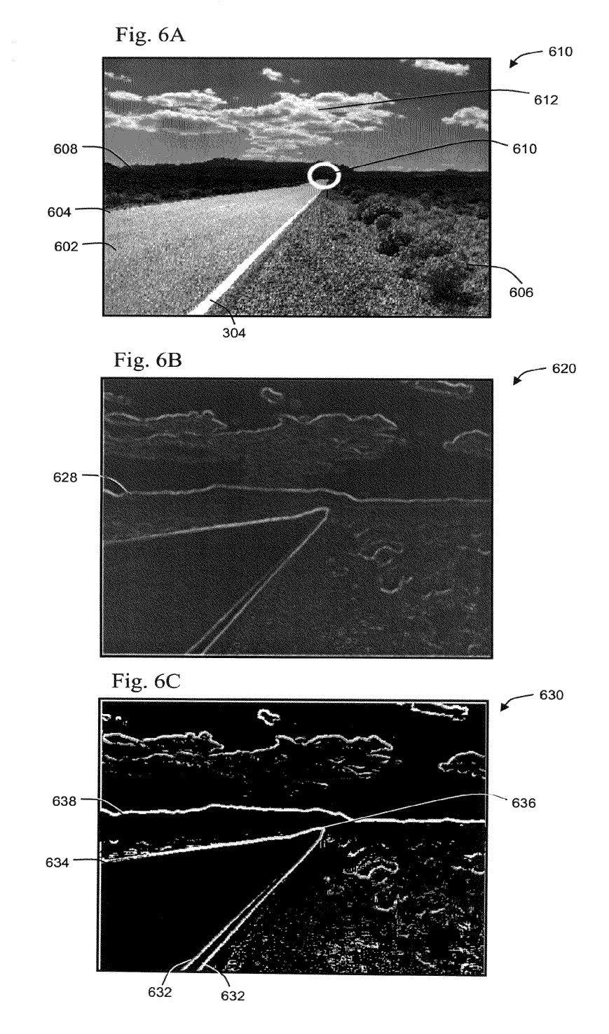

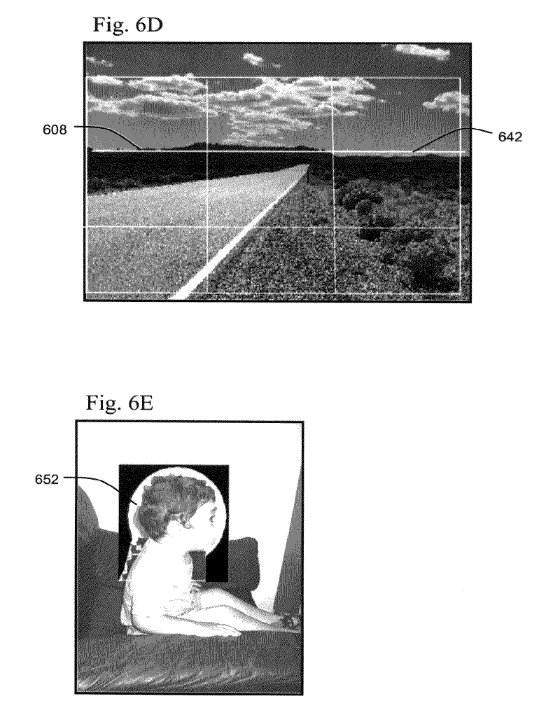

Reference is now made to FIGS. 6A-6D, which images of a common scene; each image depicts a different processing of an image that depicts the common scene, according to some embodiments of the present invention.

FIG. 6A illustrates a gray-scaled version 610 of the image, in accordance with exemplary embodiments of the invention. The gray-scaled image comprises a road 602 with side marks 604 and a hedge 606 running alongside the road, where road 602, side marks 604 and imaginary line of hedge 606 converge into a line an attractor 610 in the distance (indicated with a white circle). Image 610 also comprises a mountains ridge 608 oriented approximately horizontally, and some clouds 612. Each of the cited elements of image 610 can be considered a potential composition indicative feature, but not necessarily all of the cited composition indicative features meet a particular rule or conversely, a particular rule does fit all the composition indicative features. For example, a side or a middle of road 602 may be fitted with a diagonal of rule of harmonious diagonals, for example as shown in the pattern that is depicted in FIG. 3C, while line attractor 610 may be fitted with intersections of lines of other composition rules or eye of a golden spiral (FIG. 3E), and ridge 608 may be fitted with a line of rule of thirds, for example as shown in the pattern that is depicted in FIG. 3A.

In some embodiments of the invention, in order to determine the composition indicative features of image 610, the gradients of the image 610 are computed, for example, using Sobel or Laplace methods as described in the cited references above.

FIG. 6B illustrates a gradients image 620 of image of 610, with some visibility enhancement, in accordance with exemplary embodiments of the invention.

In order to filter out the prominent composition indicative features, in some embodiments of the invention the gradients are binarized. In some embodiments the mean values and standard deviation of the pixels of image 620 or any part thereof, for example about the center, are computed, and pixels values below mean and/or standard deviation are set as black and therefore ignored, while the rest are set as white and therefore marked as potential composition indicative features.

FIG. 6C illustrates a binarized gradients image 630 of image 620 with some visibility enhancement, in accordance with exemplary embodiments of the invention. In some embodiments of the invention, in order to determine dominance of a prominent feature such as a straight of semi-straight lines or line segments, a Hough transform, or other methods which are known in the art, is used and gradients 632 and 634 of road 602, as well as the gradient 638 of ridge 608 are selected, ignoring the irregular shapes of the gradients of clouds 612. Optionally, a line that falls below a given or a calculated length is ignored. In some embodiments of the invention, the selected lines are checked if they converge into a common point or region or small section (relative to the line or image), such as region 636 in image 630.

Optionally, the statistics of a gray scale composition indicative feature is estimated in order to score the selected composition indicative features of image 610. Optionally, a mean value, a maximal value, and/or any other statistic such as median of pixels within a selected gradient in the gray-scale gradient are computed. For example, the pixels of gradient 628 in image 620, which corresponding with a selected gradient 638 in image 630 are used to compute the statistic. In some embodiments of the invention, a composition indicative feature, such as a line having a certain pattern or characteristics, is given a score according to the statistic, where the maximal statistic value is the maximal score. Optionally, other scoring methods are used, for example, according to the width of a gradient.

In some embodiments of the invention, the score of a line or curve may be modified, for example, according to the actual or relative size of the line or curve, for example, the score multiplied by a weight based on the length.

Additionally, in some embodiments of the invention, a statistic of a region of a lines attractor or converging point or region (such as 610/636) may be evaluated to obtain a score. Optionally, a score of a converging region is modified by multiplication by a weight to increase the score, optionally to a higher score than lines.

In some embodiments of the invention, a composition indicative feature that comprises a closed form, or nearly closed form (e.g., gaps are less than half the perceived perimeter of the form, or less) have precedence over lines or attraction points, such as having a score based on a statistic and multiplied by a weight, optionally yielding a score larger than other composition indicative features. In some embodiments of the invention, the score of a closed form may be modified by a weight according to the form size (e.g., area by number of pixels, bounding rectangle, convex hull or larger extent) or distance from the image boundary.

In some embodiments of the invention, faces are detected, optionally as described, at least partly, in Robust Real-Time Face Detection, Received Sep. 10, 2001; International Journal of Computer Vision 57(2), 137-154, 2004, which is incorporated herein by reference.

In some embodiments of the invention, a face is given a-priori high score, optionally a certain percentage (such as twice) higher than the rest of the composition indicative features.

In some embodiments of the invention, a face score is modified, e.g., by multiplying by a weight, based on the face size (e.g., area by number of pixels, bounding rectangle or oval area or extent), or based on the position of the face in the image. For example, a face near the image boundary is given a lower score than a centered face, optionally relative to the distance of the face from the image boundary, or a small face is given a lower score than a larger composition indicative feature.

In some embodiments of the invention, a face score is modified according to the number of faces in the image and/or the relative size (e.g. area or extent of a bounding rectangle or oval) of a face, such that the large the face size the larger is the score and the higher the number of faces the lower is the score of the faces.

In some embodiments of the invention, an object is identified (see below) as a composition indicative feature. In some embodiments an object is classified, such as tree, plant, animal, pet, urban object, household object, or other objects. Optionally, an object is given an a-priori high score, optionally a certain percentage higher than the rest or some of the composition indicative features, optionally according to the classification. In some embodiments of the invention, an object score is modified according to its brightness and/or color relative to the surrounding thereof (contrast) such that the higher the contrast the higher the score. In some embodiments, the object score is modified similarly as the closed form or face, such as by size and position in the image. In some embodiments of the invention, when a face is detected as composition indicative feature, it is granted an a-priory score (before modifications such as by weight, see above) larger than other composition indicative features.

In some embodiments of the invention, faces or other composition indicative features that a closer than a threshold value are considered as one composition indicative feature. Optionally, the center of the group is determined by weighted centers of the features according to the features size or other methods such as center of gravity (by pixels values) or half the geometrical extent of the group. Optionally, the closeness threshold is relative to the image, e.g., 10% of the width. Optionally, the threshold is relative to the largest feature, or relative to the smallest feature. Optionally, the threshold is according to other considerations such as the difference in brightness or color of the features candidate for grouping (e.g., the larger the similarity the larger the threshold). In some embodiments, the grouping of features is based on the similarity of the scores of the candidate features, optionally according to a score threshold. Optionally, the score threshold is relative to the highest score of the features or to the lowest score or the average score or the weighted score (e.g., with respect to the features size). In some embodiments of the invention, the score of a group is the weighted score of the member features with respect to the features size (e.g., area by number of pixels, bounding rectangle, convex hull). Optionally, the score of a group is the average score of the group features. Optionally, other methods are used such as the maximal score of a feature of the group.

In some embodiments of the invention, the a-priory scores, such as for a face, and weights for modifying scores, such as by length of lines or position in the image, are pre-set. Optionally, the a-priory scores and/or the weights are determined according to the type and/or number of the composition indicative features, optionally based on pre-set scores. Optionally, the scores and weights are determined, at least partly, based on the image, for example, according the image histogram.

### Template Matching for Composition Indicative Features

In some embodiments of the invention, objects are identified in the image by using a template similar to template 364 of FIG. 3F (which would be used as an example for the rest of the discussion, unless otherwise specified). In some embodiments of the invention, the template is shaped like a silhouette of an object, such as animal, or tree or other object.

In some embodiments of the invention, the template is correlated with the image using the template as a kernel to locate in the image a pattern similar to template. In some embodiments of the invention, if a satisfactory correlation value or higher is obtained the area under the template is taken as a composition indicative feature of the object. Optionally, a satisfactory correlation value is based on the template area (in pixels) times an average or median of the image times a given threshold (e.g., 50%). Optionally, a satisfactory correlation value is determined by other methods, such as by a given value, optionally dependent on the image.

In some embodiments the image is pre-processed as described above, such as converting to gray-scale, modifying gray extent, changing brightness, contrast or gamma, to enhance features in the image. Optionally the image is ‘equalized’ yielding small range of pixel values such as to avoid false detection by correlation in a bright region that might yield high value regardless of the match, or to avoid missing a detection such as by correlating in a dark region that might yield a low value even if a good match is found.

It should be noted that in many cases, even if an object resembling the template is present in the image, in some cases it is not expected to find a match right away. Therefore, in some embodiments of the invention, the template is scaled to smaller or larger size or to different proportions or rotated and the correlation repeated. Optionally, the template is modified to resemble the object in various positions, and the correlation repeated.

In some embodiments of the invention, a particular object template is such as, or similar to, as depicted in FIG. 3F, that is, a face with a shoulders (face-side with shoulder). In some embodiments, when such a template is found, it is marked as ‘portrait’ for a special composition. Optionally, other template for a person section may be used and marked accordingly, such as a ‘belt’ for face to belt section, etc.

In some embodiments of the invention, if the correlation yielded an indeterminable value, that is, not satisfactory to establish a composition indicative feature but not low enough to be discarded, the template is modified in small changes such as to aim to obtain a satisfactory result.

In some embodiments of the invention, in order to speed up the matching the image and the correlation are down-sampled and an initial correlation is carried out rapidly (relative to full resolution). If a close match is found, the resolution is increased for a more reliable match. The correlation may be performed by using a plurality of increased resolutions for optimized performance.

In some embodiments of the invention, in case a particular desired object is not found, another desired object template is tried.

Template matching has been briefly discussed. Methods and elaborations of matching and/or detecting a pattern in an image is described, in Zhe Lin, Larry S. Davis, David Doermann, Daniel DeMenthon, “Hierarchical Part-Template Matching for Human Detection and Segmentation,” IEEE International Conference on Computer Vision (ICCV 2007), Rio de Janeiro, Brazil, 2007 and in the lecture Template matching and object recognition of Marc Pollefeys which is available in http://www.cs.unc.edu/Research/vision/comp256fall03/vision21.ppt, which the disclosures of which are incorporated herein by reference.

### Rule Fitting

In some embodiments of the invention, when a composition indicative feature have been derived and scored, the highest scored composition indicative feature is matched to fit an available rule, such as depicted in FIGS. 3A-3E (510).

In some embodiments of the invention, matching composition indicative features to a rule comprises fitting a composition indicative feature as described above for the composition rules (optionally excluding a person figure template, such as portrait (FIG. 3F) or belt as discussed above). For example, locating lines which are composition indicative features according to the rule of thirds, or locating a center of a composition indicative feature (e.g., a closed form, or a face or an object) which is about a cross section of the lines. In some embodiments of the invention, locating about a part of a line or point of a rule (e.g., cross section of lines or eye of a spiral) comprises locating within an allowed distance from the line or point. Optionally, the distance is a fraction of the image width or height of diagonal, such as 20% of the image width or height of diagonal. Optionally, the distance depends on the feature size such that the larger the feature (e.g., a closed form) the larger the allowed distance.

For example, with reference to FIGS. 3A to 3E, assuming line attractor 610 is of the highest score, trying to fit a rule to line attractor 610 fails as attractor 610 is too far away from an intersection of lines of composition rules. On the other hand, a second in score, ridge 608, fits close to the upper line of a rule of thirds 642 as shown in FIG. 6D.

In some embodiments of the invention, as a person figure is concerned, a template for identifying a face and body section is used as described above to detect the section appropriate for an expressive composition. In some embodiments of the invention, the composition rules or templates regarding faces comprise variations or extensions, for example, for a person facing the left the rule is extended to suggest placing the person at the right side of the image, and vise versa.

FIG. 6E illustrates the image of FIG. 4E (with high brightness for clarity) overlaid with a template 652 for face side, in accordance with exemplary embodiments of the invention.

In some embodiments of the invention, fitting a geometric rule (e.g., rule of thirds) comprises scaling the rule such as that the rule frame fits inside the image, preserving the rule proportions when the proportions are inherent in the rule (e.g., golden ratio). Optionally, a frame may extend outside the boundary of the image, optionally up to an allowed distance. Optionally, the distance is a fraction of the image dimension such as 5% of the image width if the frame extended beyond the width of the image.

In some embodiments of the invention, when a rule fitting is optionally followed by a composition adjusted image capture (see below), a larger margin is allowed for the frame extension outside the image boundaries, such as 20% of the respective dimension. Optionally, the subsequent image is acquired in a format (boundaries) according to the extents of the rule (see below).

### Composition Rules Application (Providing a Composition Adjusted Image)

In some embodiments of the invention, if a rule or a template is found and matched with composition indicative feature or features of the baser image, a composition adjusted image is acquired according to the frame of the rule or template (514). Optionally, if the rule frame extends outside the boundary of the image, the composition adjusted image is acquired such that the rule frame is inside the image, optionally overlapping the image boundaries or close to the boundaries within an allowed distance, such as 5% of the respective dimension. Optionally, a plurality of images are acquired and fitted with a rule, and the image with the most expressive composition is selected for a composition.

Optionally, the newly acquired image is captured with a wider zoom (larger boundaries) than the frame of the rule, providing margins for cropping the image to a fine-tuned composition.

Optionally, if a rule or template is found and fitted for the image, the image (or copy thereof) is cropped to fit the rule frame or figure template.

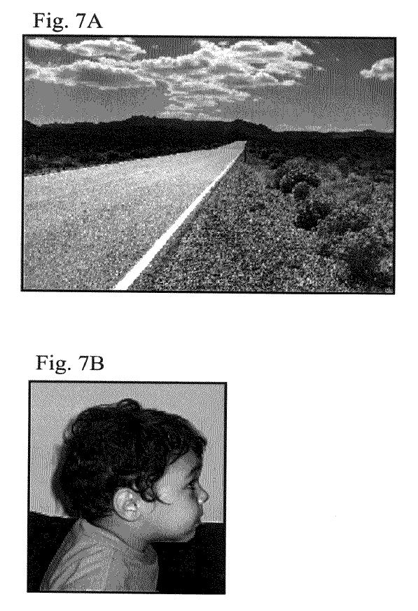

FIG. 7A illustrates the image of FIG. 6E after re-capture (or cropping) according to the rule of thirds, in accordance with exemplary embodiments of the invention.

In some embodiments of the invention, a face template (or optionally an object template) is applied regardless of the allowed distance from the image boundary.

FIG. 7B illustrates the image of FIG. 4E after re-capture (or cropping) according to the template of a person figure section, in accordance with exemplary embodiments of the invention.

In some embodiments of the invention in particular with respect to persons, without limiting, an image orientation is switched between landscape orientation and portrait orientation, optionally regardless of the allowed distance between the rule or template frame and the image.

In some embodiments of the invention, a image capturing unit such as a cellular phone or a digital image capturing unit is equipped with software and/or hardware for processing and/or analyzing a captured image to obtain composition indicative features and/or for applying the composition rules and/or templates as described above. Optionally, the analysis and composition rules application are performed on a captured image (or a copy thereof) which is optionally subsequently cropped to adapt to the rule or template frame as described.

In some embodiments of the invention, the image capturing unit is equipped with software and/or hardware for controlling (a) the optical system (such as lens and optionally the imaging device) and/or (b) capabilities of the device such as zoom and/or aiming direction, and/or (c) the triggering (image acquisition) of the device.

In some embodiments of the invention, the device automatically aims at a scene adjusting the zoom and/or direction of the lens to acquire an image in a format according to a fitted rule or template with respect to a previous image as described above.

In some embodiments of the invention, the image capturing unit acquires an image with larger extents than actually shown in the device such as in a viewfinder or screen (frame). For example, the image acquisition is zoomed out to comprise additional margin areas such as 20% of each dimension of the frame. Optionally or alternatively, the image, including the frame area, is not shown on a device.

In some embodiments the margins areas are not used for distinguishing composition indicative features, but rather may be used to allow a flexible fitting of a rule to composition indicative features in the image. For example, the margin areas provide surplus scenery range when a rule extends beyond the frame and the image is cropped according to the fitted rule or template without an additional image acquisition (provided that the margins are sufficient). Optionally or alternatively, the margin areas provide room for cropping the image when a rule extends beyond the frame, where otherwise the rule fitting, and possibly the composition, would be discarded.

In some embodiments of the invention, a region retained after cropping is enhanced such as by up-sampling (more pixels) or sharpening to compensate, at least partly, for the smaller size (in pixel count) and/or lower quality of the region relative to the device capabilities. Optionally, the aspect ratio of the retained region is adapted to a particular ratio, for example, an aspect ratio compatible with the image capturing unit such as 4:3 or 3:4.

In some embodiments of the invention, the cropping and/or capture of an image according to a rule is performed automatically. Optionally the automatic operation is performed without intervention of a user. Optionally, the image overlaid with a rule or template (e.g., like FIG. 6D or 3E) is presented to the user, with an option to accept or reject the rule application, for example, by the device buttons or soft keys such as yes-no or accept-reject. Optionally, a user may alternate between composition rules overlaid on the image and may accept a specific rule or template application.

In some embodiments of the invention, the user is presented with the cropped or re-captured image with a composition according to an application of a rule. Optionally, the user can accept or reject the composition. Optionally, the user can alternate between compositions according to other composition rules.

In some embodiments of the invention, the application of a rule and/or cropping and/or re-capture of an image are performed responsive to a user interaction. For example, a rule or template is presented on an image, and the user may move it over the image and then request the application of the rule such as by cropping the image or re-triggering the device to obtain an image according to the rule selected by the user. Optionally, the user may pan (on a larger image or by controlling the lens) and/or crop the image, optionally regardless of a rule overlay.

In some embodiments of the invention, when no rule is suitable for the image, no subsequent operation is performed. Optionally, the user is notified to that effect such as by a message or a symbol on the device screen and/or a sound.

### Combining Images

In some embodiments of the invention, when the rule frame extends outside the boundary of a base image, an image or a plurality of images comprising the missing scenery are captured and combined (‘stitched’) with the base image to provide a composition adjusted image according to the rule. In some embodiments of the invention, a part of the based image is removed, optionally to preserve the size and/or aspect ratio of the base image. Such a stitching process may be performed according to various methods which are known in the art, for example the method for assembling images which is disclosed in patent application Ser. No. 11/826,767, filed on Jul. 18, 2007, which is incorporated herein by reference.

Optionally, the combined image is processed such as by up-sampling or sharpening or other operations to preserve the size and/or aspect ratio of the base image and/or to reduce possible visual quality degradation.

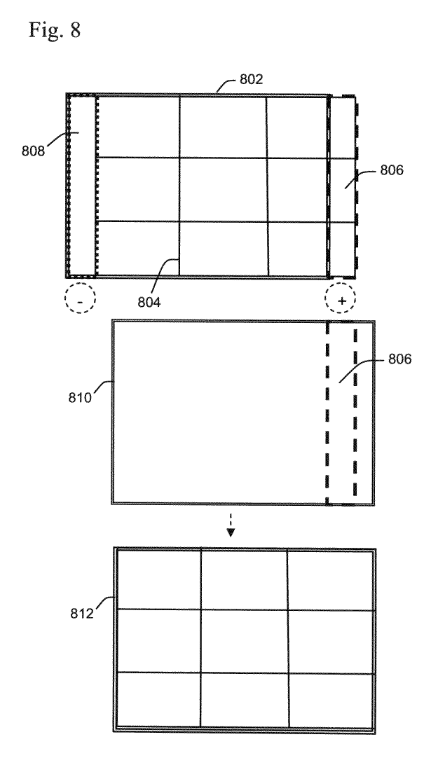

FIG. 8 schematically illustrates a how an image is appended to a base image in order to provide missing scenery for a composition, in accordance with exemplary embodiments of the invention.

In some embodiments of the invention, a rule 804 (rule of thirds, representing also other composition rules) is fitted to a feature (not shown) in base image 802. The frame of rule 804 extends beyond image 802, as illustrated by a dashed region 806. In some embodiments an additional image 810 is captured and processed to extract the scenery of region 806. The scenery in region 806 is appended on one side of base image 802 (or a copy thereof) to fill in the missing contents. Optionally, a region 808 (illustrated as a dotted region), corresponding in size to region 806, is truncated on the opposite side of base image 802 (or a copy thereof) to preserve the size and aspect ratio of base image 802. In some embodiments, base image 802 (or a copy thereof) is modified into image 812 comprising a composition according to rule 804.

### Sample Composition Flow

The following sequence illustrates how composition indicative features are matched a to a rule-of-thirds according to the features scores, including their orientations, in accordance with exemplary embodiments of the invention

(a) Detect faces in the base image

If num of faces<3

Then if faces cover>80% of the image

Then the composition is done.

(b) If faces are found in the base image

Then estimate body height.

If a full body can be included in the composition

Then define lower boundary upper limit as 20% bellow lowest foot location

Proceed from (d).

(c) If no full body can be included

Then estimate average belt height for all faces and set it as bottom height.

(d) If face(s) orientation is not frontal (for more than one face an average orientation is obtained)

Then set the center of all faces as composition indicative features.

If faces orientation is to left set faces as composition indicative features on the closest point between [1/3 1/3], [1/3 1/2], [1/3, 2/3] (upper left is [0, 0])

If faces orientation is to the right set faces as composition indicative features on the closest point between [2/3 1/3], [2/3 1/2], [2/3, 2/3] (upper left is [0, 0]).

(e) If face(s) orientation is frontal (for more than one face an average orientation is obtained)

Then set the center of all faces as composition indicative features.

Set faces as composition indicative features on the closest point between [1/3 1/3], [1/3 1/2], [1/3, 2/3], [2/3 1/3], [2/3 1/2], [2/3, 2/3] (upper left is [0, 0]).

(f) Finding one or more objects with dominant edges in picture, for example finding the sky and/or the sky line.

If sky line is at least approximately horizontal and located between ⅙ and ½ height (upper left is [0, 0])

Then set line in ⅓ height

If sky line is at least approximately horizontal and located between ½ and ⅚ height (upper left is [0, 0])

Then set line in ⅔ height

If sky line is not at least approximately horizontal but least approximately smooth

Then if the line has a peak

Then set the line in ⅔ height

Else if the line has a minimum

Then set the in ⅓ height.

Optionally, the face orientation is determined by placing vertexes of a triangle on the two eyes and the mouth center of a virtual face and/or by any known method for detecting faces, for example using a Viola-Jones face detecting process, as described above.

### Potential Benefits

Digital image capturing units are typically used by many people not trained in photography. Furthermore, as cellular phones and handsets and PDAs are recently equipped with image capturing units, in many cases the pictures are taken casually or instantly without much care on the composition. Having an automatic composition facilities built into the image capturing units or other mobile photography equipment allows the users to work as they are used to, while providing a reasonable or satisfactory composition, typically much better than theirs ordinary photography manners.

Additional potential benefit of having an automatic composition capability in an image capturing unit is by allowing capturing reasonably composed pictures in occasions such as an event, when there is not much time to prepare the capture, or when the user has to move around.

### General

All trademarks are the property of their respective owners.

In the specifications and claims, unless otherwise specified, the terms ‘software’, ‘program’, ‘procedure’ or ‘module’ or ‘code’ may be used interchangeably and denote one or more instructions, comprises in a storage medium, and executable by a computing apparatus (such as computer, processor, or a DSP or a dedicated apparatus).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein, the terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a procedure” or “at least one procedure” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The present invention has been described using detailed descriptions of embodiments thereof that are provided by way of example and are not intended to necessarily limit the scope of the invention. The described embodiments comprise different features, not all of which are required in all embodiments of the invention. Some embodiments of the invention utilize only some of the features or possible combinations of the features. Alternatively and additionally, portions of the invention described/depicted as a single unit may reside in two or more separate physical entities which act in concert to perform the described/depicted function. Alternatively and additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to, use of features described in the context of one embodiment in the context of any other embodiment.

What is claimed is:

1. A method for capturing a composition adjusted image, comprising:
a) receiving a base image;
b) processing said base image to derive coordinates of a composition adjusted image having a composition matching with at least one predefined composition rule; and
c) capturing said composition adjusted image according to said coordinates.

2. The method of claim 1, wherein said base image depicts at least one composition indicative feature, said processing comprises matching between said at least one composition indicative feature and a predefined template.

3. The method of claim 2, wherein said predefined template is selected from a group consisting of a face, a person, a posture, a section of a person body, a scenery contour and an animal.

4. The method of claim 2, wherein said processing comprises evaluating a member selected from a group consisting of: the area of said at least one composition indicative feature, the shape of said at least one composition indicative feature, and the contour of said at least one composition indicative feature, said matching being performed according to said evaluation.

5. The method of claim 1, wherein said base image depicts at least one element, said matching comprises matching between an arrangement of said at least one element in said base image and said at least one predefined composition rule.

6. The method of claim 1, wherein said processing comprises scoring a plurality of composition indicative features in said base image, said matching being performed according to said scoring.

7. The method of claim 1, wherein each said predefined composition rule is weighted, said matching being performed according to said weighting.

8. The method of claim 1, wherein said processing is performed automatically in response after said a).

9. The method of claim 1, wherein said capturing is performed by an image capturing unit, said capturing comprises instructing said image capturing unit to capture said composition adjusted image according to said coordinates.

10. The method of claim 9, wherein said image capturing unit instructing comprises a member selected from a group consisting of: zooming said image capturing unit, directing the viewpoint of said image capturing unit, and adjusting the exposure time of said image capturing unit.

11. The method of claim 9, wherein said capturing comprises cropping said base image to form said composition adjusted image according to said coordinates.

12. The method of claim 1, wherein the resolution of said base image is lower than the resolution of said composition adjusted image.

13. The method of claim 1, wherein said base image is a frame of a video sequence.

14. The method of claim 1, wherein said at least one predefined composition rule is selected from a group consisting of: the rule of thirds, the rule of golden diagonals, the rule of harmonious diagonals, and the rule of golden sections, the rule of golden spiral.

15. The method of claim 1, further comprising preprocessing said base image before said b), wherein said preprocessing is selected from a group consisting of: converting said base image to a gray-scale image, binarizing said base image, distinguishing edges in said base image, and segmenting visual elements having an area above a size threshold.

16. The method of claim 1, wherein capturing comprises combining at least a part of the base image with at least a part of the captured image.

17. The method of claim 1, wherein said receiving comprises accessing a storage unit hosting said base image.

18. The method of claim 1, wherein said receiving comprises using an image capturing unit for capturing said base image.

19. The method of claim 1, further comprising creating a downgraded base image before said b), said downgraded base image having lower resolution than said base image, said processing being performed on said downgraded base image.

20. The method of claim 1, wherein said capturing comprises capturing a new image and combining at least one region of said base image with said at least one region of said new image, thereby creating said composition adjusted image.

21. The method of claim 1, wherein said base image is captured by an image capturing device, further comprising indicating a user to maneuver said image capturing device according to said composition adjusted image before said c).

22. The method of claim 1, wherein said processing comprises scoring a plurality of composition indicative features in said base image, said indicating being performed according to said scoring.

23. A apparatus for capturing a composition adjusted image, comprising:
an image capturing unit configured for capturing a base image;
a memory configured for storing a plurality of predefined composition rules;
a composition analysis module configured for analyzing said base image and deriving coordinates of a composition adjusted image therefrom, said composition adjusted image having a composition matching with at least one of said plurality of predefined composition rules; and
a capturing module configured for capturing said composition adjusted image according to said coordinates.

24. The apparatus of claim 23, further comprising a user interface for displaying an indicator indicative of a recommended maneuver for maneuvering said image capturing unit, said recommended maneuver being calculated according to the compliance of said base image with said plurality of predefined composition rules.

25. The apparatus of claim 23, wherein said capturing module is configured for instructing said image capturing unit to capture said composition adjusted image.

26. The apparatus of claim 23, wherein said image capturing unit is configured for capturing said base image in a first resolution and said composition adjusted image in a second resolution, wherein said first and second resolutions are different.

27. The apparatus of claim 25, wherein said capturing module is configured for instructing said image capturing unit by a member selected from a group consisting of: zooming said image capturing unit, directing the viewpoint of said image capturing unit, and adjusting the exposure time of said image capturing unit.

28. The apparatus of claim 23, wherein said capturing module is configured for capturing a new image and combining at least one region of said base image with at least one region of said new image.

29. The apparatus of claim 23, wherein said apparatus is selected from a group consisting of: a mobile phone, a personal digital assistant (PDA), and a handheld computing unit.

30. A method for capturing a composition adjusted image, comprising:
a) receiving a base image from an image capturing device;
b) processing said base image to derive a plurality of coordinates each of a composition adjusted image having a composition matching with at least one predefined composition rule;
c) scoring each coordinate according to a compliance of said composition adjusted image with a respective said at least one predefined composition rule; and
d) using said scoring for indicating a recommended maneuver for said image capturing device.

31. The method of claim 30, further comprising allowing a user to capture a final image after maneuvering said capturing device according to said recommended maneuver.
